(19) United States
(12) Patent Application Publication
(10) Pub. No.: US 2016/0303586 A1
(43) Pub. Date: Oct. 20, 2016

(54) Sprinkler

(71) Applicant: YUAN-MEI CORP., CHANGHUA COUNTY (TW)

(72) Inventor: SHUN-NAN LO, CHANGHUA COUNTY (TW)

(21) Appl. No.: 15/193,123

(22) Filed: Jun. 27, 2016

Related U.S. Application Data
(63) Continuation-in-part of application No. 14/685,606, filed on Apr. 14, 2015.

(51) Int. Cl. B05B 3/04; B05B 3/08; B05B 15/06; B05B 1/16

(52) U.S. Cl. CPC B05B 3/04; B05B 1/1636; B05B 1/169; B05B 3/08; B05B 15/065

(57) ABSTRACT

A sprinkler includes a main body and a duct rotary unit rotatably sleeved at the main body, wherein the duct rotary unit includes a plurality of nozzles with different spraying patterns. A baffle is formed on top of the duct rotary unit and is stationary when the duct rotary unit is rotated, such that when the duct rotary unit is rotated, the baffle is stationary and is aligned with one of the nozzles as a selected nozzle for spraying operation.

### CROSS REFERENCE OF RELATED APPLICATION

This is a Continuation-In-Part application that claims priority to U.S. non-provisional application No. 14/685,606, filed Apr. 14, 2015, the entire contents of each of which are expressly incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a sprinkler of an irrigation system, and in particular to a sprinkler with adjustable spray patterns.

2. Description of Related Arts

There are various kinds of irrigation systems in the art, wherein the present case, in particular, focuses on sprinkler heads with selectable nozzles. Such type of spraying head allows the users to choose watering mode according to various environments or needs of the plant, so as not to damage the plants.

US. Pat. No. 5,746,374, titled “Rotary sprinkler having a turret assembly”, discloses a rotary sprinkler, which can switch among nozzles for different watering modes. In order to evenly spray and disperse water splash from the nozzle, its rotary assembly has a deflector. The deflector has a long flat portion to be fixed on the top of the rotary housing and to synchronously rotate with the rotary assembly. In other word, when the rotary assembly is turned, the deflector will synchronously be turned with the rotary assembly. As a result, it brought a major drawback that because the deflector is fixed on the top of the rotary assembly and cannot be turned independently, it can only be used for a specific one of the nozzles.

In the interest of flexible irrigation application, a sprinkler having a spray adjustment applicable to more than one of the selectable nozzles is desired.

### SUMMARY OF THE PRESENT INVENTION

According to the present invention, an irrigation sprinkler, adapted for connecting to a water supply, is disclosed. The irrigation sprinkler includes a main body, a rotary unit, a cover body, and a baffle. The main body includes a main shaft and an outlet communicating with the water supply. The rotary unit is sleeved at the main shaft in a rotatably movable manner. The rotary unit includes a plurality of nozzles having different spraying configurations. The cover body is coupled at the main shaft in a stationary manner. The baffle is coupled to the cover body. When the rotary unit is manually rotated with respect to the main body to align the outlet to a selected one of the nozzles, the baffle remains stationary and synchronously align with the selected nozzle.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of a sprinkler according to a preferred embodiment of the present invention.

FIG. 2 is an exploded perspective view of a cover body of the sprinkler according to the above preferred embodiment of the present invention.

FIG. 3 is an exploded side view of the sprinkler according to the above preferred embodiment of the present invention.

FIG. 4 is a sectional view of the sprinkler according to the above preferred embodiment of the present invention.

FIG. 5 is a sectional view of the sprinkler according to the above preferred embodiment of the present invention, illustrating the water flow direction in the sprinkler.

FIG. 6 is a side view of the sprinkler according to the above preferred embodiment of the present invention.

FIG. 7 is a sectional view of a modified sprinkler according to the above preferred embodiment of the present invention, illustrating the protruded baffle at an extended position.

FIG. 8 is a sectional view of the modified sprinkler according to the above preferred embodiment of the present invention, illustrating the protruded baffle at a retracted position.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

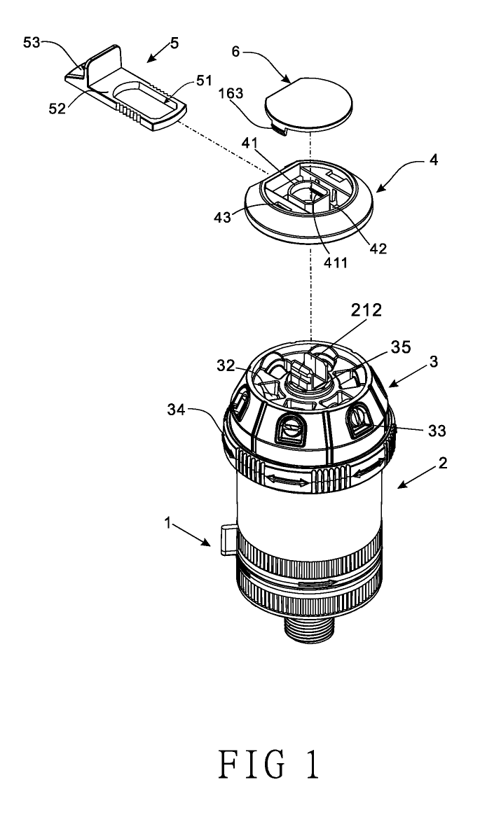

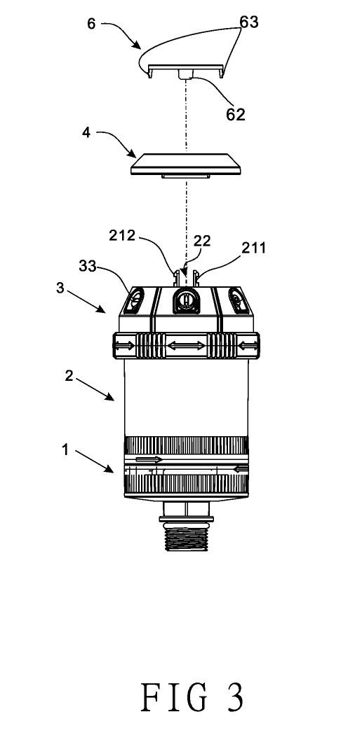

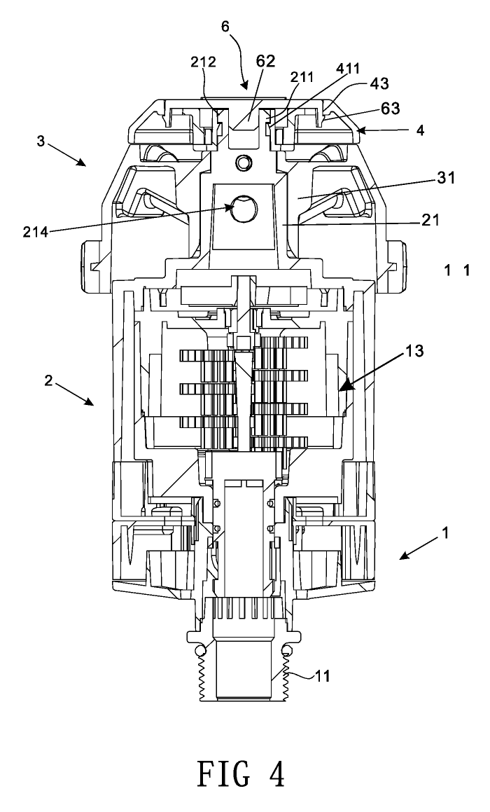

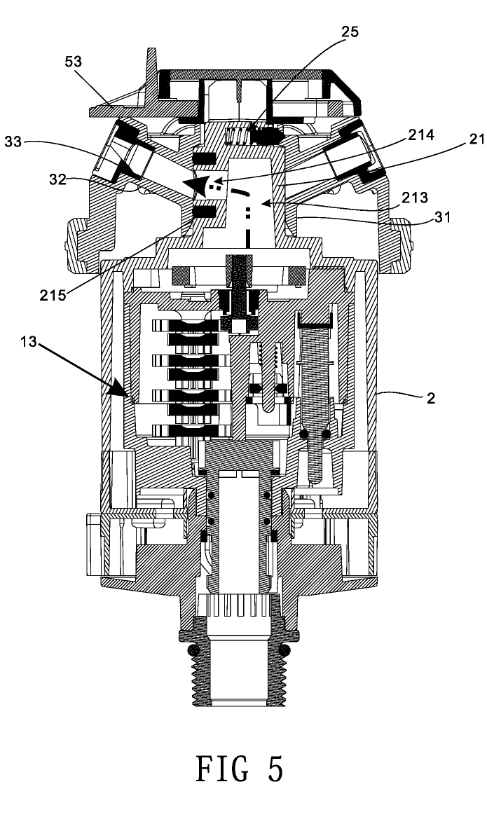

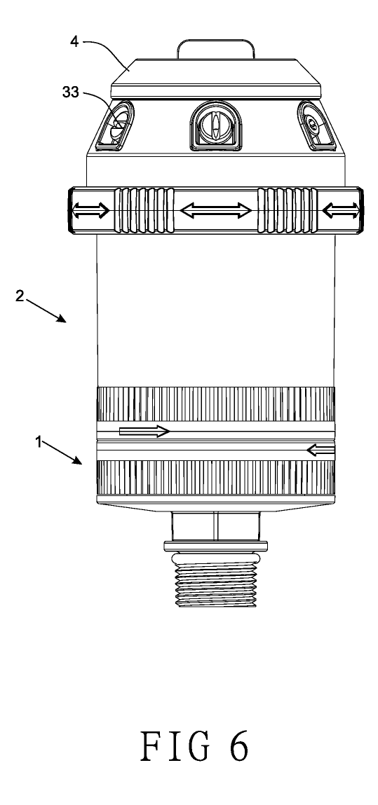

FIGS. 1 through 8 pertain to a first embodiment of the present invention. The sprinkler comprises a base 1, a main body 2, a rotary unit 3, a cover body 4, and a baffle 5.

The base 1 comprises a driving mechanism 13 communicatively connecting to a water supply and driven by the water flow.

The main body 2 is rotatably coupled at the base and driven by the driving mechanism in order to rotatably move with respect to the base 1. The main body 2 includes a main shaft 21 integrally protruded from a top center thereof, wherein the main shaft 21 has a channel 213. The main shaft 21 includes an outlet 214 extended radially and communicating with the channel 213. The end surface of the outlet 214 has a ring seal 215 sleeved thereon. A pair of resilient plates extend from the top end of the main shaft 21 and each resilient plate includes a assembling groove 211. A spacing 22 is formed between the resilient plates. A resilient positioning member 25 is disposed on a radial end of the main shaft 21.

The rotary unit 3 includes a shaft sleeve 31 for receiving the main shaft 21 of the main body 2, so that the rotary unit 3 can be rotated with respect to the main body 2 through a manual operation. A plurality of nozzles 33 are arranged at the peripheral wall of the rotary unit 3. The nozzles 33 respectively have different spraying patterns or configurations. A plurality of ducts 32 radially extends from the shaft sleeve 31 and respectively communicates with the inlets of the nozzles. A plurality of positioning points 35 are encirclingly formed at the interior wall of the shaft sleeve 31, wherein the positioning points 35 are located and distributed corresponding to the positions of the ducts 32.

The cover body 4 includes a hollow anchor 41, a reception 42 formed around the hollow anchor 41, two insertion slits 43 formed on two opposing sides of the reception 42. The internal wall of the hollow anchor 41 has a pair of assembling ribs 411. The hollow anchor 41 of the cover body 4 sleeves on the resilent plates. Meanwhile, the assembling grooves are buckled at the assembling ribs in a tight and inseparable manner. Therefore, the cover body 4 is tightly coupled on the resilient plates of the main shaft 21 to prevent the cover body 4 from being rotated with respect to the main shaft 21. In other words, the cover body 4 is stationary when the rotary unit 3 is rotated.

The baffle 5 has a flat portion 52, movably coupled at the cover body 4. The flat portion 52 of the baffle 5 extends to form a tongue 53. The flat portion 52 of the baffle 5 also has an elongated hole 51. The flat portion 52 inserts into the reception 42 of the cover body 4 while the elongaged hole 51 sleeves on the hollow anchor 41. The radial length of the elongated hole 521 is greater than a width of the hollow anchor 41. The baffle is able to slide between an extended position and a retracted position in a radial direction corresponding to the outlet 214 of the main shaft 21. At the extended position of the baffle 5, it deflects the water jet from the selected nozzle 33 and reduces the irrigation area of the spray thereof.

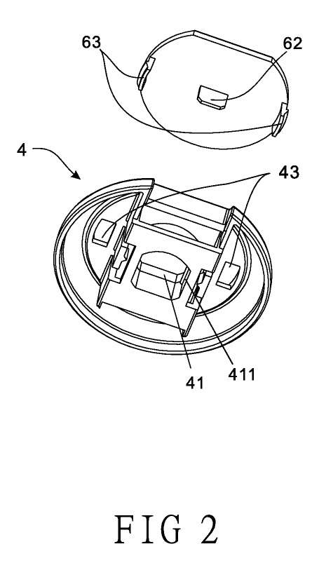

Referring to FIGS. 1 and 2, the sprinkler further comprises a cap 6 securely coupled to the cover body 4, wherein the cap 6 has a pair of insertion buckles 63 alignedly inserted into the insertion slits 43 of the cover body 4 respectively. The bottom surface of the cap 6 forms a board unit 62, which buckles on the spacing 22 of the main shaft 21 to slightly expand the resilient plates [##], such that the assembling grooves 211 can further tightly buckle on the assembling ribs 412. Therefore, the cap 6 can be tightly and inseparably buckled on the cover body 4. Also, the baffle 5 can be further tightly and inseparably secured on the cover body 4. It is worth mentioning that the baffle 5 can still slide between the extended position and the retracted position within a limited distance.

In particular, the main body 2 sleeves on the base 1. The rotary unit 3 sleevingly mounts on top of the main body 2. The cover body 4 is mounted on top of the duct rotary unit 3. The cap 6 is mounted on top of the cover body 4.

The sprinkler further comprises an adjustment unit 34 provided at the peripheral wall of the duct rotary unit 3. The user is able to grip the adjustment unit 34 to rotate the rotary unit 3 so as to selectively adjust one of the nozzles 33 aligning with the outlet 214. The positioning member 25 pushes against one of the positioning points 35 to retain the rotary unit 3 at the selected position.

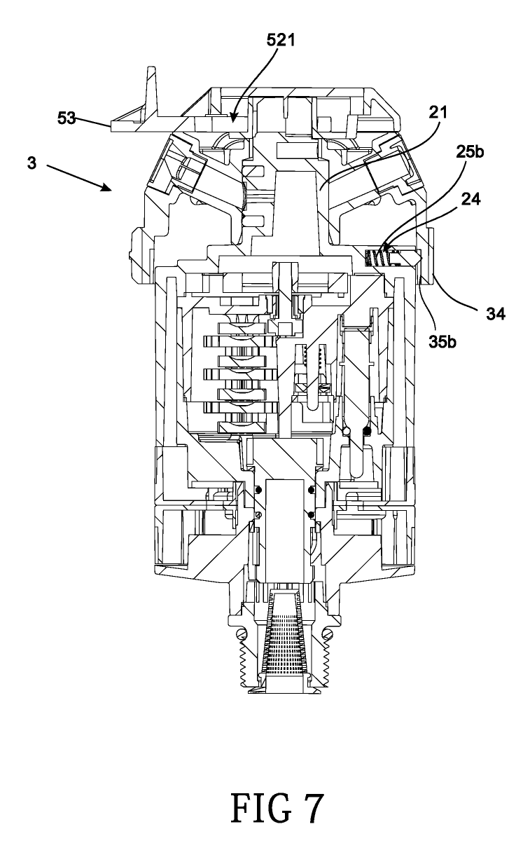

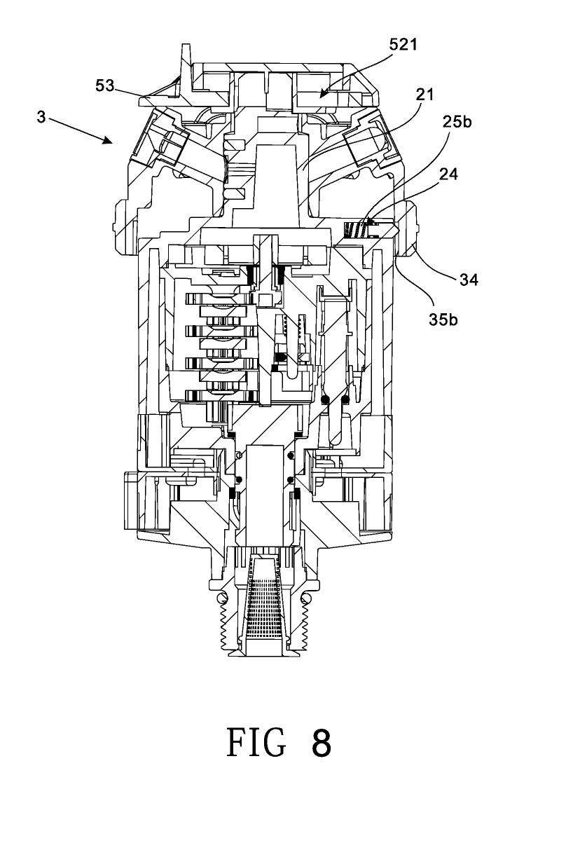

FIGS. 7 and 8 illustrate an alternative embodiment of the sprinkler. The positioning units 35b are formed at an inner wall of the rotary unit 3 at the bottom portion thereof, wherein the positioning points 35b are located and distributed corresponding to the ducts 32. The resilient positioning member 25b is disposed radially at the bottom end of the main body 2.

Furthermore, the baffle 5 is movably coupled at the cover body 4 which is mounted on top of the rotary unit 3. In particular, the cover body 4 is mounted on the main shaft 21 of the main body 2 and the cover body 4 is stationary, i.e. non-turnable. The baffle 5 is allowed to slide a limited distance at an end of the cover body 4.

As shown in FIGS. 7 and 8, the baffle 5 is actuated to adjust the diffusion angle of the water sprayed from the selected nozzle 33. As the baffle 5 is manually pulled to slide at the extended position, the tongue 53 serves as a protruded blocker, so as to block and push down the elevated spray sprayed from the nozzle 33. Therefore, the spray can be blocked and pushed down by the tongue 53 and the angle of the spray is reduced with a lower spraying angle. When the baffle 5 is manually pushed in to slide at the retracted position, the water spray from the nozzle 33 will not be blocked by the tongue 53, such that the spray of the nozzle 33 will shift back with an elevation angle.

In an alternative embodiment (not illustrated), the cap is omitted. The cover body 4 comprises an elongaged hole, and the baffle comprises two retaining buckles which pass through the elongated hole and retain the baffle. Refer to FIG. 14 of U.S. Pat. No. 7,255,291 for more details.

One characteristic of the present invention is that while the rotary unit is rotated, the cover body is stationary, therefore the baffle will not be driven to rotate. Once a nozzle is selected, the baffle synchronously align with the selected nozzle. The baffle, therefore, can be used for any one of the nozzles.

Another characteristic of the present invention is that the baffle consistently align with the selected nozzle and therefore also function as a visual indicator of the nozzle selection.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A sprinkler, adapted for connecting to a water supply, comprising:
a main body comprising a main shaft thereon and an outlet communicating with the water supply;
a rotary unit sleeved at said main shaft of said main body in a rotatably movable manner, wherein said rotary unit comprises a plurality of nozzles and a plurality of ducts, wherein each of said ducts has an inlet selectively coupled at said outlet, wherein said nozzles are coupled at said ducts respectively;
a cover body coupled at said main shaft in a stationary manner; and
a baffle coupled at said cover body, wherein when said rotary unit is rotated with respect to said main body, said outlet of said main body is aligned with one of said ducts to select one of said nozzles as a selected nozzle while said pattern adjustment component is stationary at said cover body to align with said selected nozzle.

2. The sprinkler, as recited in claim 1, wherein said baffle comprises a tongue and is movable between an extended position and a retracted position.

3. The sprinkler, as recited in claim 1, wherein said main body further comprises a pair of assembling units extended from a top end of said main shaft, wherein said cover body comprises two inserting units and has a pipe and two grooves oppositely extended from said pipe to said inserting units which extend from tops of said grooves to form a platform, wherein said pipe of said cover body is sleeved and coupled on said assembling units that said cover body is stationary when said rotary unit is rotate.

4. The sprinkler, as recited in claim 1, wherein said baffle has a flat portion defining said tongue and has an elongated hole formed thereon, wherein said elongated hole is aligned with a pipe of said cover body, so as to linearly slide between said extended position and said retracted position in a limited distance along said pipe, wherein a sliding direction of said tongue aligns with said outlet of said main shaft.

5. A sprinkler, comprising:
a base adapted for communicatively connecting to a water supply;
a main body rotatably coupled on said base, wherein said main body comprises a main shaft extended upwardly, wherein said main shaft has a channel and an outlet extended radially from said channel;
a rotary unit sleeved at said main shaft of said main body in a manually and rotatably movable manner, wherein said rotary unit comprises a plurality of nozzles, and a plurality of ducts extended radially, wherein each of said ducts has an inlet selectively coupled at said outlet of said main shaft, wherein said nozzles are coupled at said ducts respectively;
a cover body coupled at said main shaft in a stationary manner; and
a baffle movably coupled at said cover body and being moved between an extended position and a retracted position, wherein said baffle comprises a tongue, wherein when said rotary unit is rotated with respect to said main body, said outlet of said main shaft is aligned with one of said ducts to select one of said nozzles as a selected nozzle while said baffle is stationary at said cover body to align with said selected nozzle.

6. A sprinkler, comprising:
a base adapted for communicatively connecting to a water supply;
a main body rotatably coupled on said base, wherein said main body comprises a main shaft extended upwardly, wherein said main shaft has a channel and an outlet extended radially from said channel, wherein said main body further comprises a pair of assembling units extended from a top end of said main shaft;
a rotary unit having an axle channel sleeved at said main shaft of said main body in a rotatably movable manner, wherein said rotary unit comprises a plurality of nozzles having different spraying configurations, and a plurality of ducts extended radially, wherein each of said ducts has an inlet selectively coupled at said outlet of said main shaft, wherein said nozzles are coupled at said ducts respectively;
a cover body coupled at said main shaft in a stationary manner, wherein said cover body has a pipe being sleeved and coupled on said assembling units that said cover body is stationary when said rotary unit is rotate;
a baffle movably coupled at said cover body and being moved between an extended position and a retracted position, wherein said baffle has a flat portion and an elongated hole formed thereon, wherein said baffle is linearly slid in a limited distance along said pipe that said baffle is only allowed to slide at a radial direction of said cover body, wherein said flat portion of said baffle forms a tongue, wherein a sliding direction of said tongue aligns with said outlet of said main shaft; and
a cap securely coupled on said cover to retain said baffle immovable at said cover body, wherein when said rotary unit is rotated with respect to said main body, said outlet of said main shaft is aligned with one of said ducts to select one of said nozzles as a selected nozzle while said baffle is stationary at said cover body to align with said selected nozzle.
